(19) United States
(12) Patent Application Publication
(10) Pub. No.: US 2016/0107150 A1
(43) Pub. Date: Apr. 21, 2016

(54) NON-PLATINUM BASED AMMONIA OXIDATION CATALYSTS AND APPLICATIONS ON AFTERTREATMENT SYSTEMS

(71) Applicant: GM GLOBAL TECHNOLOGY OPERATIONS LLC, DETROIT, MI (US)

(72) Inventors: ERIC D. THOMAS, SHELBY TOWNSHIP, MI (US); GONGSHIN QI, TROY, MI (US)

(21) Appl. No.: 14/516,632

(22) Filed: Oct. 17, 2014

(51) Int. Cl. B01J 29/85; B01D 53/94; B01J 35/04

(52) U.S. Cl. CPC B01J 29/85; B01J 35/04; B01D 53/9477; B01D 2255/904

(57) ABSTRACT

An aftertreatment system utilizes chemical reactions to treat an exhaust gas flow. A device for use within an aftertreatment system includes a platinum-free ammonia oxidation catalyst comprising palladium to treat ammonia slip in the exhaust gas flow. In one embodiment, the catalyst includes a Pd/Cu/SAPO-34 catalyst used within a selective catalytic reduction device or in a device downstream of the selective catalytic reduction device.

### TECHNICAL FIELD

This disclosure is related to control of aftertreatment of NOx emissions from internal combustion engines.

### BACKGROUND

The statements in this section merely provide background information related to the present disclosure. Accordingly, such statements are not intended to constitute an admission of prior art.

Emissions control is one factor in engine design and engine control. One particular emission, NOx, is a known by-product of combustion. NOx is created by nitrogen and oxygen molecules present in engine intake air disassociating in the high temperatures of combustion, and rates of NOx creation include known relationships to the combustion process, for example, with higher rates of NOx creation being associated with higher combustion temperatures and longer exposure of air molecules to the higher temperatures.

NOx molecules, once created in the combustion chamber, can be converted back into nitrogen and H2O molecules in exemplary devices known in the art within the broader category of aftertreatment devices. Aftertreatment devices are known, for instance, utilizing chemical reactions to treat an exhaust gas flow. One exemplary device includes a selective catalytic reduction device (SCR). An SCR utilizes a reductant capable of reacting with NOx to treat the NOx. One exemplary reductant is ammonia derived from urea injection. A number of alternative reductants are known in the art. Ammonia stored on a catalyst bed within the SCR reacts with and treats NOx.

Ideally, ammonia provided within an aftertreatment system would be entirely used up within the aftertreatment system. However, a condition known as ammonia slip occurs, in particular at high temperature operation of the aftertreatment system, where ammonia is passed downstream of the device wherein it is intended to be stored and used. Platinum catalysts are widely used to convert slipped ammonia and prevent discharge of the ammonia out of the exhaust system. Such catalysts ideally convert ammonia into harmless components including molecular nitrogen. However, platinum catalysts include limitations. One exemplary performance metric, nitrogen selectivity, measures how much slipped ammonia is converted into nitrogen gas by the catalyst instead of the NOx. In certain ranges, platinum catalysts show a poor nitrogen selectivity.

### SUMMARY

An aftertreatment system utilizes chemical reactions to treat an exhaust gas flow. A device for use within an aftertreatment system includes a platinum-free ammonia oxidation catalyst comprising palladium to treat ammonia slip in the exhaust gas flow. In one embodiment, the catalyst includes a Pd/Cu/SAPO-34 catalyst used within a selective catalytic reduction device or in a device downstream of the selective catalytic reduction device.

### BRIEF DESCRIPTION OF THE DRAWINGS

One or more embodiments will now be described, by way of example, with reference to the accompanying drawings, in which:

FIG. 1 illustrates an exemplary aftertreatment system treating an exhaust gas flow from an engine, in accordance with the present disclosure;

FIG. 2 graphically illustrates exemplary test results showing ammonia storage for a tested SCR device including a palladium catalyst, in accordance with the present disclosure;

FIG. 3 graphically illustrates exemplary test results showing operation of a palladium catalyst through a temperature range, in accordance with the present disclosure; and

FIG. 4 graphically illustrates exemplary test results showing higher nitrogen selectivity in the disclosed catalyst, in accordance with the present disclosure.

### DETAILED DESCRIPTION

Depending upon a number of variables, aftertreatment systems can include a number of different components or modules, including diesel oxidation catalysts (DOC), selective catalytic reduction (SCR) devices, diesel particulate filters (DPF), and three way catalysts (for use in gasoline powered systems.) These various modules can be arranged in various ways. The examples provided within the disclosure are intended as non-limiting examples, and the disclosure is not intended to be limited to the examples provided herein.

An SCR device receives a supply of ammonia, for example, from a flow of urea provided by a urea injector device, to treat NOx within the aftertreatment system. An SCR device includes an SCR catalyst material in the form of a coating or a brick to store ammonia and facilitate the chemical reaction that occurs within the SCR device, speeding the conversion of NOx and ammonia into desired exhaust components including nitrogen gas and water.

Ammonia slip from the SCR catalyst is treated with an ammonia oxidation catalyst, for example, including platinum. Such a catalyst must be capable of treating ammonia to nitrogen and water once it has slipped or been released from the intended storage device or catalyst. In one exemplary configuration, the ammonia catalyst can be located within the SCR device. In another embodiment, the ammonia oxidation catalyst can be located in a downstream of SCR device. The ammonia oxidation catalysts could be used as a HC/CO oxidation catalysts, similar to a DOC and catalyzed DPF.

Platinum catalysts include limitations such as poor nitrogen selectivity in certain temperature ranges. Testing has shown that palladium can be used as a catalyst in place of platinum and has shown improved nitrogen selectivity as compared to platinum.

An exhaust aftertreatment system is disclosed utilizing a platinum-free palladium catalyst within an exhaust aftertreatment device. Such a palladium catalyst can be utilized in isolation of other active chemical agents. According to another embodiment of the disclosure, a palladium catalyst can be tied to a zeolite compound for additional ammonia storage properties. One such zeolite compound is known as silicoaluminophosphate 34 (SAPO-34). SAPO-34 is known in the art. Exemplary properties of the SAPO-34 is discussed in “POROUS ALUMINOPHOSPHATES: From Molecular Sieves to Designed Acid Catalysts” Annu. Rev. Mater. Res. 2005. 35:351-95 doi: 10.1146/annurev.matsci.35.103103.120732, which is incorporated herein by reference. According to one exemplary embodiment, the palladium can be utilized as or within a Pd/Cu/SAPO-34 catalyst. The catalyst can be used in an SCR device, a DOC device, or any device where a platinum catalyst is known to be used. Catalyst washcoat variations can include a flow thorough substrate, a wall flow substrate, zone coatings in SCR catalysts, zone coatings in selective catalytic reduction-on-filter (SCRF) catalysts.

Referring now to the drawings, wherein the showings are for the purpose of illustrating certain exemplary embodiments only and not for the purpose of limiting the same, FIG. 1 illustrates an exemplary aftertreatment system treating an exhaust gas flow from an engine. Exemplary diesel engine 10 is illustrated, combusting a fuel air mixture to generate mechanical power, and as a result of the combustion, an exhaust gas flow including chemical byproducts of the combustion process is forced through exhaust aftertreatment system 12. Exemplary aftertreatment system 12 includes a first DOC device 20, an SCR device 30, and a second DOC device 40. Urea injector device 50 is illustrated supplied with a flow of urea which is injected into the aftertreatment system 12 upstream of SCR device 30. SCR device 30 includes an exemplary Pd/Cu/SAPO-34 catalyst according to the disclosure in order to facilitate treatment of NOx within device 30. The arrangement of devices within aftertreatment system 12 is exemplary and non-limiting, and other configurations and other devices utilizing ammonia oxidation catalysts can similarly be arranged and utilized.

Palladium can be incorporated as a catalyst in a number of ways. In an exemplary washcoat method, three options for forming the catalyst are provided. First, palladium catalysts can dispersed as a separate layer on top of SCR catalysts applied within the device. Second, palladium catalysts can dispersed as a separate layer under SCR catalysts applied within the device. Third, palladium catalysts can be dispersed uniformly within a washcoat with SCR catalysts applied within the device.

An exemplary preparation method for a Cu/SAPO-34 catalyst includes the following. An ion-exchanged Cu/SAPO-34 catalyst is prepared by a two-step liquid ion-exchange method. A commercial H/SAPO-34 powder (Noble, Al:Si:P=1:0.1:0.9, obtained by inductively coupled plasma and atomic emission spectrometry) is ion-exchanged using a NH₄NO₃ (Alfa Aesar, >95%) solution at 80° C. for 1 hour to obtain the NH₄⁺ form. Then the solid is filtered and washed with distilled water. The NH₄⁺/SAPO-34 is dried at 100° C. for 16 hours before repeating the ammonium exchange process for a total of two exchanges. Cu ion-exchange is performed by mixing the NH₄⁺/SAPO-34 with a Cu(CH₃COO)₂ solution (0.05 mol/L) at ambient temperature for 6 hours. After the powder is filtered and washed with distilled water, it is dried at 100° C. for 16 hours and calcined at 550° C. for 4 hours.

Once the above Cu/SAPO-34 catalyst is prepared, palladium can be added to create Pd/Cu/SAPO-34 through the following exemplary procedure. Pre-determined amounts of a palladium precursor solution are added to Cu/SAPO-34 catalyst preparation so that the internal pores of the Cu/SAPO-34 particles are flooded with the precursor solution. These impregnated Cu/SAPO-34 particles are then dried and calcined under the same conditions to the Cu/SAPO-34. After calcination, the powder Pd/Cu/SAPO-34 is ball milled with water for 24 hours. The ball-milled slurry is washcoated onto round cylindrical monolith core samples which are ¾ inch diameter by one inch long, 400 channels per square inch of inlet face area, 4 mil wall thicknesses, extruded and fired cordierite honeycomb bodies. This procedure is repeated until the desired loading is obtained on the channel walls of the cordierite substrate body. Finally, the catalyst washcoated body is calcined at 700° C. for 5 hours with an air flow rate of 100 sccm. The targeted total washcoat loading is 120 grams per liter of the outer (superficial volume) of the monolith body and palladium loading is 15 g/ft³. After washcoating, each monolithic catalyst is dried and calcined at 550° C. for 5 hrs in air. Before testing, the sample were aged at 750° C. for 2 hours under 10% H₂O/air.

According to other embodiments of the Pd/Cu/SAPO-34 catalyst, palladium loading values can be utilized between 2-20 g/ft³. According to other embodiments of the disclosed platinum-free palladium catalyst, other possible zeolites include Beta, ZSM-5, SSZ-13, Y, SAPO-5, SAPO-11. According to other embodiments of the disclosed platinum-free palladium catalyst, other possible metals include iron, cobalt, nickel, and manganese.

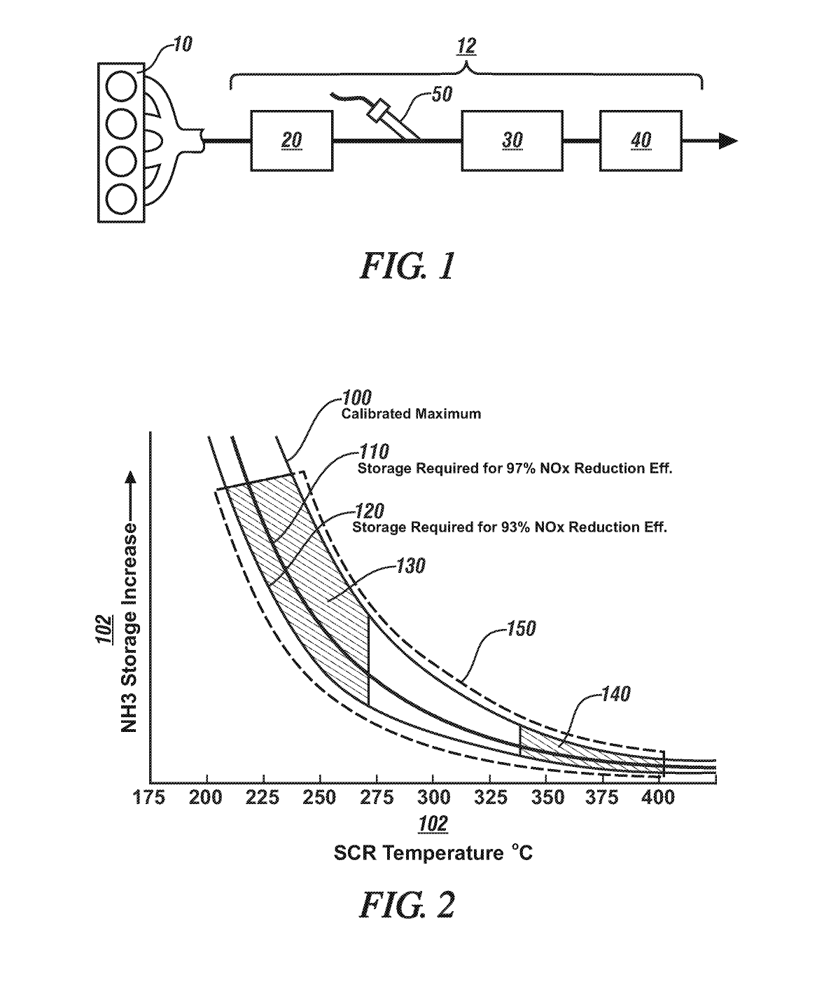

FIG. 2 graphically illustrates exemplary test results showing ammonia storage for a tested SCR device including a palladium catalyst. Vertical axis 102 provides increasing NOx storage values ascending the axis. Horizontal axis 104 provides increasing SCR temperature values in degrees Celsius. A first contour 100 is provided illustrating a calibrated maximum ammonia storage value for each temperature. A second contour 110 is provided illustrating ammonia storage values corresponding to 97% NOx reduction efficiency. A third contour 120 is provided illustrating ammonia storage values corresponding to 93% NOx reduction efficiency. Known catalysts such a platinum catalysts can operate in particular ranges of temperature values, but are limited by properties such as nitrogen selectivity. Zones 130 and 140 are provided as regions that particular catalysts can operate. Because both zones 130 and 140 illustrate temperature limited ranges, neither catalyst represented by zone 130 or zone 140 can operate to prevent ammonia slip through the entire illustrated temperature range. Zone 150 illustrates operation of a palladium catalyst according to the disclosure, providing for operation preventing ammonia slip throughout the entire illustrated temperature range.

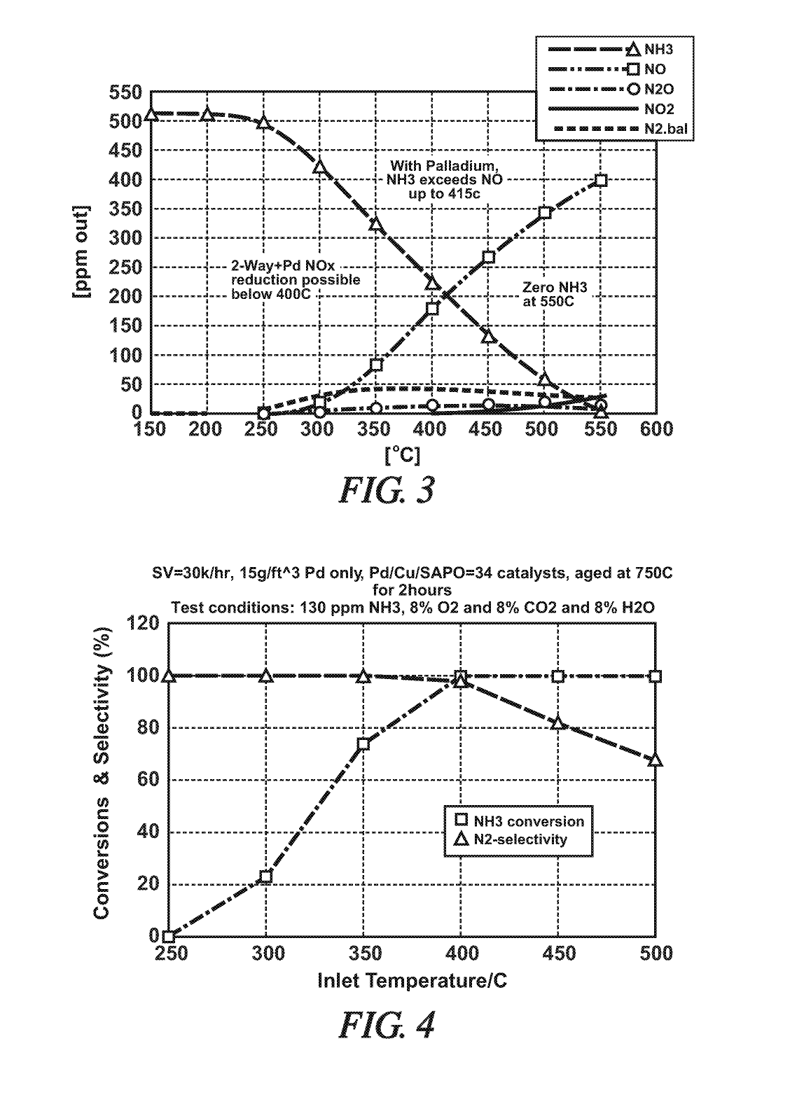

FIG. 3 graphically illustrates exemplary test results showing operation of a palladium catalyst through a temperature range. The results illustrate that 2-way+palladium reduction is possible below 400° C.; with palladium, ammonia exceed NO concentration up to 415° C.; and zero ammonia is present at 550° C.

FIG. 4 graphically illustrates exemplary test results showing acceptable rates of nitrogen selectivity in the disclosed catalyst. The illustrated test included SV=30 k/hr; 15 g/ft³ Pd only; Pd/Cu/SAPO-34 catalysts; aged at 750° C. for 2 hours; 130 ppm NH₃, 8% 02, 8% CO₂, and 8% H₂0.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A device for aftertreatment of an exhaust gas flow, the device comprising:
a platinum-free ammonia oxidation catalyst comprising palladium.

2. The device of claim 1, wherein the device further comprises a selective-catalytic reduction device.

3. The device of claim 2, wherein the catalyst comprises a catalyst brick within the selective-catalytic reduction device.

4. The device of claim 2, wherein the catalyst is dispersed as a separate layer under a selective catalytic reduction catalyst applied within the device.

5. The device of claim 2, wherein the catalyst is dispersed as a separate layer on top a selective catalytic reduction catalyst applied within the device.

6. The device of claim 2, wherein the catalyst is dispersed uniformly within a washcoat with selective catalytic reduction catalysts applied within the device

7. The device of claim 1, wherein the device further comprises a diesel oxidation catalyst.

8. The device of claim 7, wherein the catalyst comprises a catalyst brick within the diesel oxidation catalyst device.

9. The device of claim 1, wherein the catalyst is applied as a washcoat upon a flow thorough substrate.

10. The device of claim 1, wherein the catalyst is applied as a wall flow substrate.

11. The device of claim 1, wherein the catalyst is applied as zone coatings within one of a selective catalytic reduction catalyst and a selective catalytic reduction-on-filter catalysts.

12. The device of claim 1, wherein the catalyst further comprises a zeolite selected from the group consisting of Beta, ZSM-5, SSZ-13, Y, SAPO-5, SAPO-11, and SAPO-34.

13. The device of claim 1, wherein the catalyst further comprises a Pd/Cu/SAPO-34 catalyst.

14. The device of claim 1, wherein the catalyst includes palladium loading values between 2 g/ft³ and 20 g/ft³.

15. The device of claim 1, wherein the catalyst includes a palladium loading value of 15 g/ft³.

16. The device of claim 1, wherein the catalyst further comprises a metal selected from iron, cobalt, nickel, and manganese.

17. A system for aftertreatment of an exhaust gas flow, the system comprising:
at least one device including a platinum-free ammonia oxidation catalyst comprising palladium.

18. The system of claim 17, wherein the catalyst is located within a selective catalytic reduction device utilizing ammonia to treat the exhaust gas flow.

19. The system of claim 18, further comprising a diesel oxidation catalyst device using a second platinum-free palladium catalyst.
